(19) United States
(12) Patent Application Publication
(10) Pub. No.: US 2026/0356411 A1
(43) Pub. Date: Nov. 12, 2026

(54) ROBOT

(71) Applicant: LG ELECTRONICS INC., Seoul (KR)

(72) Inventors: Hansol SONG, Seoul (KR); Jinhyeok PARK, Seoul (KR); Pilyoung JEON, Seoul (KR); Junhyuk KIM, Seoul (KR)

(73) Assignee: LG ELECTRONICS INC., Seoul (KR)

(21) Appl. No.: 19/488,411

(22) PCT Filed: Jul. 21, 2023
(86) PCT No.: PCT/KR2023/010575

§ 371 Date: Nov. 26, 2025

(51) Int. Cl. B62B 5/04; B25J 5/00

(52) U.S. Cl. CPC B62B 5/049; B25J 5/007

(57) ABSTRACT

A robot is disclosed. The robot of the present disclosure may comprise: a movable cart which is equipped with wheels; a robotic arm which is mounted on the cart; a docking station to or from which the cart is connected or separated; and a guide rail which is aligned with the docking station between same and the cart, wherein the wheels may move along the guide rail.

### TECHNICAL FIELD

The present disclosure relates to a robot. In particular, the present disclosure relates to a robot including a cart and a docking station with which the cart docks.

### BACKGROUND ART

A robot is a machine capable of performing tasks autonomously. Robots have played a significant role in production automation and have evolved into intelligent robots in recent years. Intelligent robots are robots that recognize external environments, assess situations, and execute necessary tasks autonomously.

Intelligent robots may be broadly categorized into industrial robots and service robots. Unlike conventional industrial robots, which perform tasks in environments isolated from humans, collaborative robots work alongside humans to provide assistance or perform tasks for humans. Such collaborative robots enhance productivity by performing tasks while physically interacting with humans in the same space as humans. Service robots provide various services in social infrastructure to improve the convenience of human life. Recently, there has been a lot of research on such intelligent robots.

Conventional robot carts have the problem of requiring a lot of labor from workers for setup. In addition, when moving a robot cart to a new position or resetting the same to the original position thereof, it is also necessary to perform a lot of labor.

### DETAILED DESCRIPTION OF INVENTION

### Technical Problems

It is an object of the present disclosure to solve the above and other problems.

Another object may be to provide a structure that enables a robot cart to be quickly and accurately installed in a docking station.

Another object may be to provide a structure capable of minimizing the labor required by an operator to install the robot cart in the docking station.

Another object may be to provide a structure capable of securing the rigidity of the robot cart installed in the docking station.

Another object may be to provide a structure and method that allows the operator to easily set up connections such as power, pneumatic control, and communication between the robot cart and the docking station.

### Technical Solution

In accordance with an aspect of the present disclosure for achieving the above and other objects, a robot may include: a movable cart including a wheel, a robot arm mounted on the cart, a docking station to which the cart is connected or from which the cart is separated, and a guide rail aligned with the docking station between the cart and the docking station, wherein the wheel may move along the guide rail.

### Effect of Invention

A robot according to the present disclosure may have the following effects.

In accordance with at least one of embodiments of the present disclosure, it is possible to provide a structure that enables a robot cart to be quickly and accurately installed in a docking station.

In accordance with at least one of embodiments of the present disclosure, it is possible to provide a structure capable of minimizing the labor required by an operator to install the robot cart in the docking station.

In accordance with at least one of embodiments of the present disclosure, it is possible to provide a structure capable of securing the rigidity of the robot cart installed in the docking station.

In accordance with at least one of embodiments of the present disclosure, it is possible to provide a structure and method that allows the operator to easily set up connections such as power, pneumatic control, and communication between the robot cart and the docking station.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF THE DRAWING

FIGS. 1 to 16 are views showing examples of robots according to embodiments of the present disclosure.

### MODE FOR CARRYING OUT THE INVENTION

Hereinafter, the embodiments disclosed in the present specification will be described in detail with reference to the accompanying drawings, and the same or similar elements are denoted by the same reference numerals even though they are depicted in different drawings and redundant descriptions thereof will be omitted.

In the following description, with respect to constituent elements used in the following description, the suffixes “module” and “unit” are used or combined with each other only in consideration of ease in the preparation of the specification, and do not have or serve different meanings.

Also, in the following description of the embodiments disclosed in the present specification, a detailed description of known functions and configurations incorporated herein will be omitted when it may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions included in the idea and scope of the present disclosure.

Although terms including ordinal numbers, such as “first” and “second,” may be used herein to describe various components, these components should not be limited by these terms. These terms are only used to distinguish one component from another component.

It should be understood that, when a component is referred to as being “connected to” or “coupled to” another component, it may be directly connected to or coupled to another component or intervening components may be present. In contrast, it should be understood that, when a component is referred to as being “directly connected to” or “directly coupled to” another component, there are no intervening components present.

Singular forms are intended to include plural forms as well, unless the context clearly indicates otherwise.

In the present application, it should be understood that the terms “includes,” “has,” etc. specify the presence of stated features, numbers, steps, operations, elements, components, or combinations thereof, but do not preclude the presence or addition of one or more other features, numbers, steps, operations, elements, components, or combinations thereof.

Directional designations shown in the drawings, such as upward U or y, downward D, leftward Le or x, rightward Ri, forward F or z, and rearward R, are for illustrative purposes only and are not intended to limit the technical ideas disclosed herein.

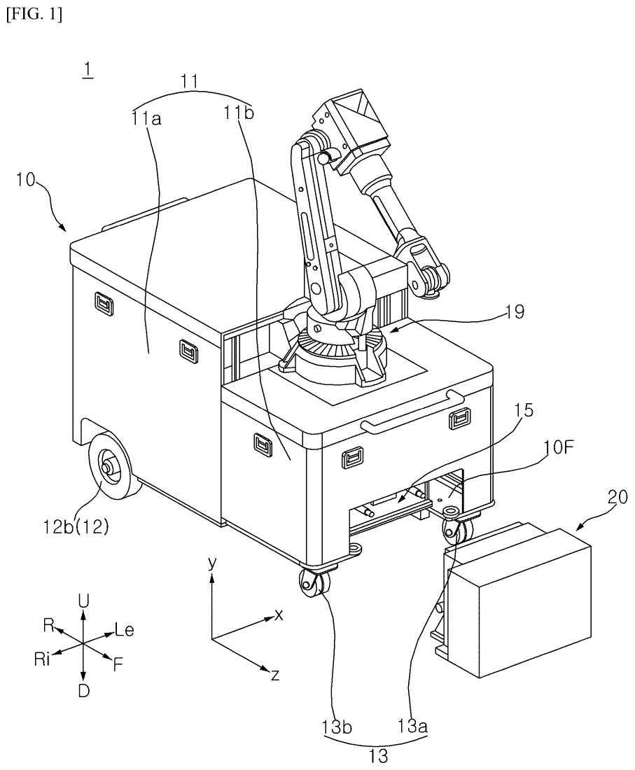

Referring to FIG. 1, a robot 1 may include a cart 10 and a docking station 20. The cart 10 may be referred to as a moving cart 10, a docking cart 10, or a cabinet 10. The robot 1 may be referred to as a docking module 1, a docking assembly 1, a docking system 1, or a robot system 1.

The cart 10 may include a frame 10F, a case 11, and wheels 12 and 13. The frame 10F may form a framework of the cart 10. Components embedded in the cart 10 can be mounted on the frame 10F. The case 11 may be connected to the frame 10F and form the exterior of the cart 10. The case 11 may cover the components mounted on the frame 10F. The cart 10 may move on the ground by means of the wheels 12 and 13 mounted on a lower side of the frame 10F. A pair of driving wheels 12 spaced apart from each other in a leftward-rightward direction may be mounted on a lower side of the rear of the cart 10, and a pair of sub-wheels 13 spaced apart from each other in the leftward-rightward direction may be mounted on a lower side of the front of the cart 10. The sub-wheels 13 may be swivel caster wheels.

A robot arm 19 may be mounted on the cart 10. The robot arm 19 may be a multi-jointed arm, and may be referred to as a manipulator 19. Accordingly, the cart 10 may provide coordinates to the robot arm 19, and the robot arm 19 may operate on the coordinates provided by the cart 10.

The docking station 20 may be fixed at a specific position. A user may move the cart 10 toward the docking station 20 to dock the cart 10 with the docking station 20. The user may separate the cart 10 from the docking station 20. Alternatively, the cart 10 may move autonomously to dock with the docking station 20 or to separate therefrom.

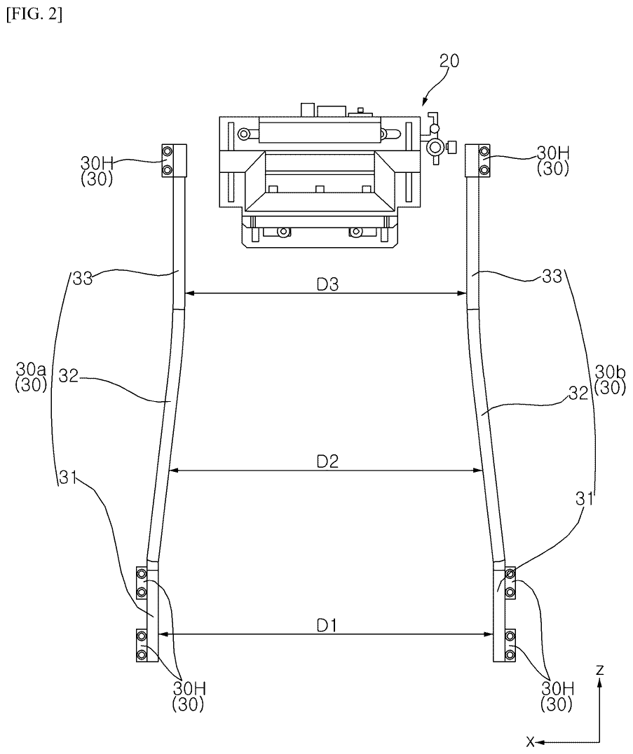

Referring to FIG. 2, a guide rail 30 may be fixed to the ground via a plurality of holders 30H. The guide rail 30 may be aligned with the docking station 20 between the cart 10 (see FIG. 1) and the docking station 20. The guide rail 30 may be a rod or a round bar having a groove into which the wheels are movably inserted.

For example, one guide rail (not shown) may extend along the center of the docking station 2 in a forward-backward direction. The longitudinal axis of the guide rail may be aligned with the docking station 20. In this case, a sub-wheel (not shown) may be mounted on the center of the lower side of the front of the cart 10 and may move along a groove of the guide rail.

In another example, a pair of guide rails 30a and 30b may be spaced apart from each other in the leftward-rightward direction, and the docking station 20 may be fixed to the ground between the pair of guide rails 30a and 30b. The central axis between the pair of guide rails 30a and 30b may be aligned with the docking station 20. In this case, the pair of sub-wheels 13a and 13b may move along sides of the pair of guide rails 30a and 30b.

The first guide rail 30a may include a rear part 31, a middle part 32, and a front part 33. The rear part 31 may extend in the forward-backward direction. The middle part 32 may extend from a front end of the rear part 31 toward the docking station 20, and may be inclined from the rear part 31. The front part 33 may extend from a front end of the middle part 32 in the forward-backward direction.

The second guide rail 30b may include a rear part 31, a middle part 32, and a front part 33. The rear part 31 may extend in the forward-backward direction. The middle part 32 may extend from a front end of the rear part 31 toward the docking station 20, and may be inclined from the rear part 31. The front part 33 may extend from a front end of the middle part 32 in the forward-backward direction.

The first and second guide rails 30a and 30b may be symmetrical to each other in the leftward-rightward direction. The distance D1 between the rear parts 31 of the first and second guide rails 30a and 30b may be greater than the distance D3 between the front parts 33 of the first and second guide rails 30a and 30b. The distance D2 between the middle parts 32 of the first and second guide rails 30a and 30b may gradually decrease from the rear to the front. The area between the rear parts 31 of the first and second guide rails 30a and 30b may be referred to as an entry area, the area between the middle parts 32 of the first and second guide rails 30a and 30b may be referred to as a guide area, and the area between the front parts 33 of the first and second guide rails 30a and 30b may be referred to as a docking area. The docking station 20 may be located in the docking area, and the left-right width of the docking station 20 may be equal to or less than the distance D3.

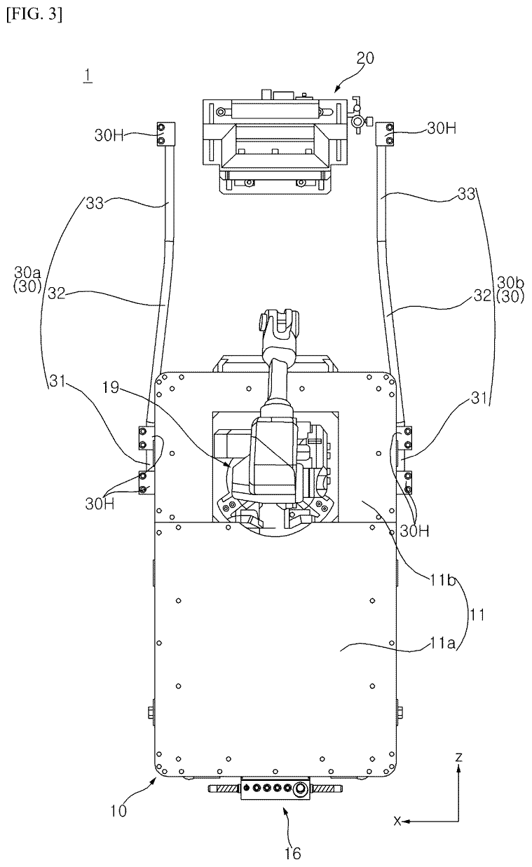

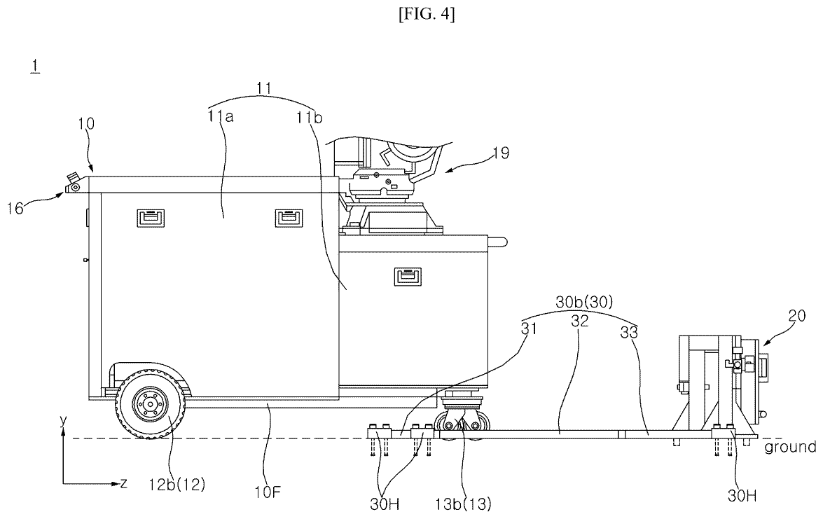

Referring to FIGS. 3 and 4, the front of the cart 10 may enter between the rear parts 31 of the first and second guide rails 30a and 30b. The pair of sub-wheels 13 may be located between the rear parts 31 of the first and second guide rails 30a and 30b. The distance (see FIG. 1) between the pair of sub-wheels 13 may be less than the distance D1 (see FIG. 2) between the rear parts 31 of the first and second guide rails 30a and 30b. Asa result, the front of the cart 10 may smoothly enter between the first and second guide rails 30a and 30b.

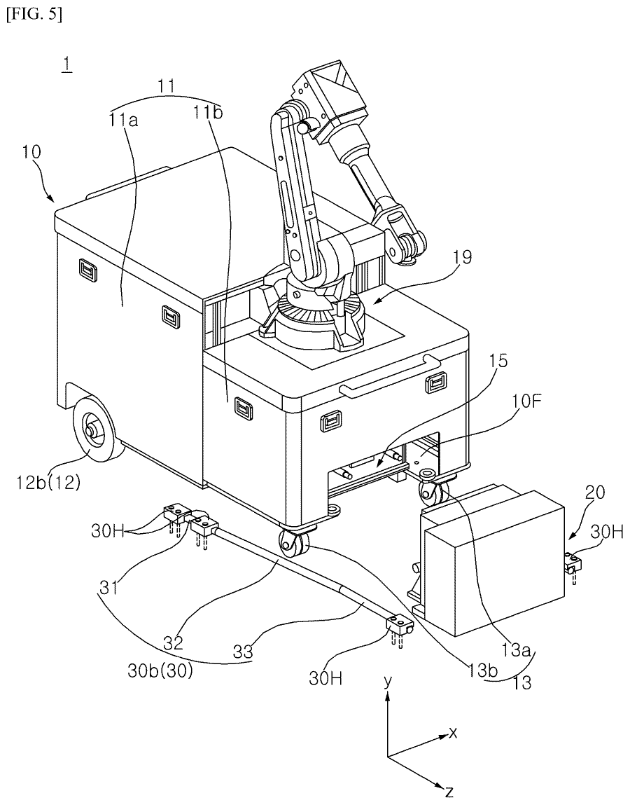

Referring to FIG. 5, the cart 10 may move forward toward the docking station 20, and the pair of sub-wheels 13 may be located between the middle parts 32 of the first and second guide rails 30a and 30b. The distance D2 (see FIG. 2) between the middle parts 32 of the first and second guide rails 30a and 30b may gradually decrease from the rear to the front, and the pair of sub-wheels 13 may move along the middle parts 32 of the first and second guide rails 30a and 30b. As a result, the cart 10 may be gradually aligned with the docking station 20 while moving forward.

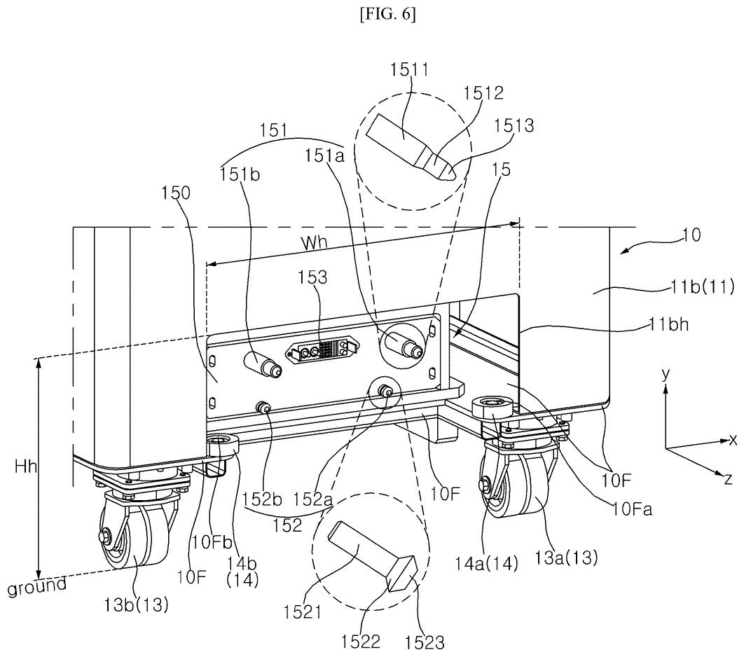

Referring to FIG. 6, a hole 11bh may be formed in a lower side of the front of the case 11 inwardly of the case 11. The hole 11bh may be a quadrangular notch having a certain width Wh and height. An upper boundary of the hole 11bh may be spaced apart upward from the ground by a certain distance Hh. The hole 11bh may provide a passageway configured to allow a docking unit 25 of the docking station 20, a description of which will follow, to pass therethrough.

A guide roller 14 may be mounted on the frame 10F so as to be adjacent to the hole 11bh, and may be rotatable about a vertical axis (i.e., a y-axis). The guide roller 14 may include a material such as rubber, silicone, or urethane. For example, a pair of rollers 14a and 14b may be spaced apart from each other in the leftward-rightward direction. The first roller 14a may be adjacent to a left boundary of the hole 11bh, and may be rotatably coupled to a first shaft 10Fa protruding upward from the frame 10F. The second roller 14b may be adjacent to a right boundary of the hole 11bh, and may be rotatably coupled to a second shaft 10Fb protruding upward from the frame 10F.

A connection unit 15 may be mounted on the frame 10F between the first and second rollers 14a and 14b, and can be exposed to the rear through the hole 11bh. The connection unit 15 may include a block 150, a guide pin 151, a fixing pin 152, and a first connector 153.

The block 150 may have an overall quadrangular prism shape. The guide pin 151 may protrude rearward from a rear surface of the block 150, and may be adjacent to an upper side of the block 150. For example, a pair of guide pins 151a and 151b may be spaced apart from each other in the leftward-rightward direction. The fixing pin 152 may protrude rearward from the rear surface of the block 150 and may be adjacent to a lower side of the block 150. For example, a pair of fixing pins 152a and 152b may be spaced apart from each other in the leftward-rightward direction. The fixing pin 152 may be referred to as a clamp pin 152 or an anchor shaft 152. The first connector 153 may be mounted on the rear surface of the block 150, and may be located between the pair of guide pins 151a and 151b.

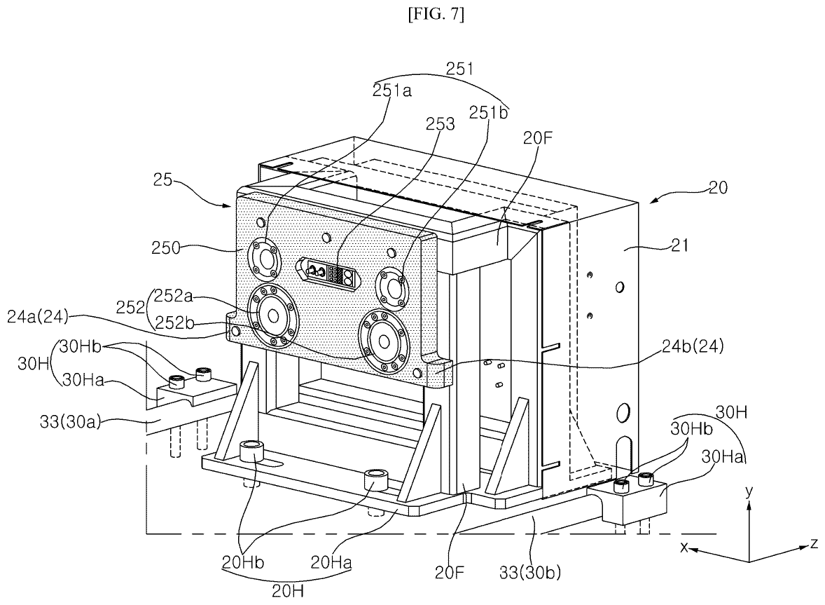

Referring to FIG. 7, the frame 20F may form a framework of the docking station 20. A mount 20H may be formed at a lower end of the frame 20F. A mount body 20Ha may be placed on the ground, and a fixing member 20Hb, such as an anchor bolt, may be fixed to the ground via the mount body 20Ha. A cover 21 may be coupled to the frame 20F at the rear of the frame 20F, and may cover the components embedded in the docking station 20. Meanwhile, the holder 30H may include a holder body 30Ha that surrounds the guide rails 30a and 30b and a fixing member 30Hb (e.g., an anchor bolt) fixed to the ground via the holder body 30Ha.

The docking unit 25 may be mounted on the front of the frame 20F, and may be adjacent to an upper side of the frame 20F. The left-right width of the docking unit 25 may be less than the width Wh of the hole 11bh in the case 11, and the distance between the ground and an upper end of the docking unit 25 may be less than the distance (Hb) between the ground and the hole 11bh. As a result, the hole 11bh may pass by the docking unit 25. The docking unit 25 may include a base 250, a guide hole 251, a fixing unit 252, and a second connector 253.

The base 250 may have an overall flat quadrangular prism shape. The guide hole 251 may be formed in the front of the base 250, and may be adjacent to an upper side of the base 250. The guide hole 251 may correspond to the guide pin 151 (see FIG. 6). For example, a pair of guide holes 251a and 251b may be spaced apart from each other in the leftward-rightward direction. The fixing unit 252 may be formed at the front of the base 250, and may be adjacent to a lower side of the base 250. The fixing unit 252 may correspond to the fixing pin 152 (see FIG. 6). For example, a pair of fixing units 252a and 252b may be spaced apart from each other in the leftward-rightward direction. The second connector 253 may be mounted on the front of the base 250, and may be located between the pair of guide holes 251a and 251b.

A guide part 24 may be formed at one side of the base 250 facing the guide roller 14 (see FIG. 6), and may have a rounded corner (i.e., a fillet). The guide part 24 may protrude from the one side of the base 250. For example, a first guide part 24a may protrude leftward from a left side of the base 250, and may be adjacent to a lower side of the base 250. For example, a second guide part 24b may protrude rightward from a right side of the base 250, and may be adjacent to the lower side of the base 250.

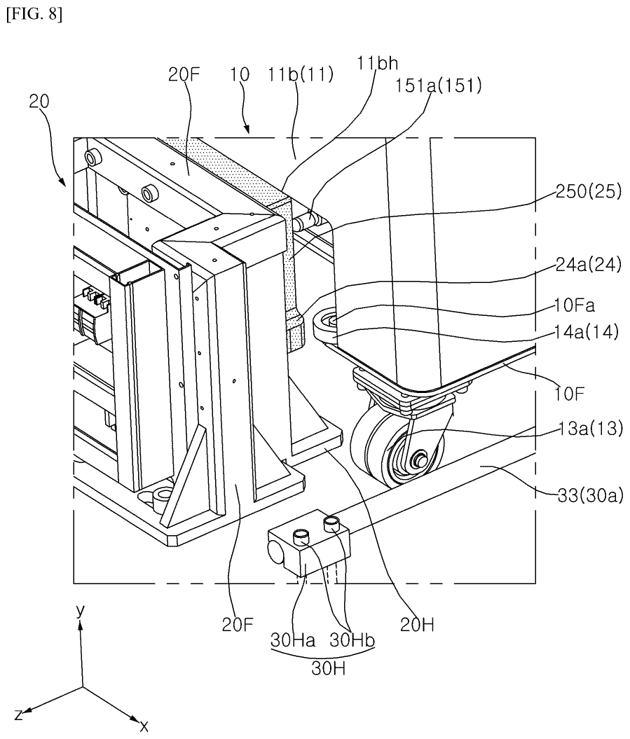

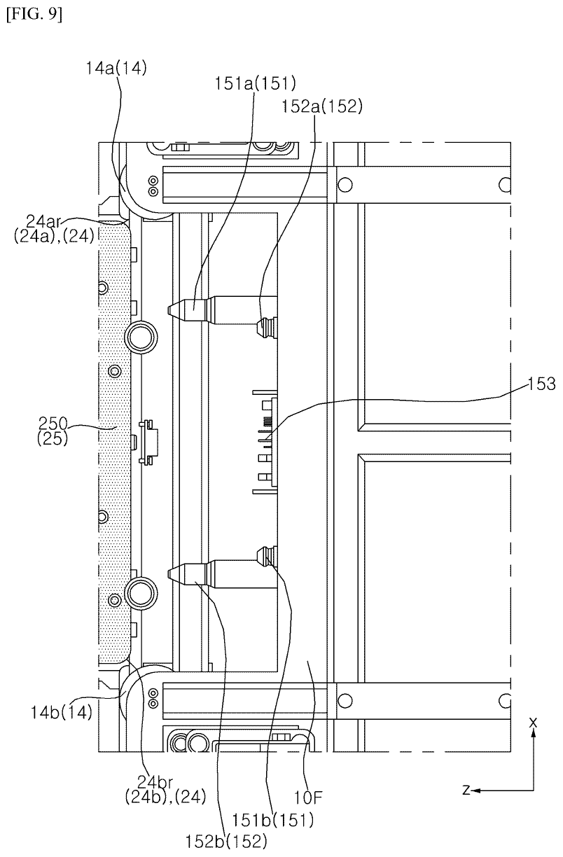

Referring to FIGS. 8 and 9, the cart 10 may move forward toward the docking station 20, and the pair of sub-wheels 13 may be located between the front parts 33 of the first and second guide rails 30a and 30b. The distance between the pair of sub-wheels 13 may be equal to or slightly less than the distance D3 (see FIG. 2) between the front parts 33 of the first and second guide rails 30a and 30b. As a result, the cart 10 may be mostly aligned with the docking station 20 between the front parts 33 of the first and second guide rails 30a and 30b.

The distance between the first guide part 24a and the second guide part 24b may be equal to or less than the distance between the first guide roller 14a and the second guide roller 14b. A left side 24ar (i.e., a left front corner) of the front of the first guide part 24a may be rounded, and may be referred to as a first fillet 24ar. A right side 24br (i.e., a right front corner) of the front of the second guide part 24b may be rounded, and may be referred to as a second fillet 24br.

As the cart 10 moves forward toward the docking station 20, the docking unit 25 of the docking station 20 may be inserted into the hole 11b of the cart 10. At this time, even if the cart 10 is offset to the right relative to the docking station 20, the first guide roller 14a moves to the left while rotating along the first fillet 24ar of the first guide part 24a, whereby the cart 10 may be gradually aligned with the docking station 20. Alternatively, even if the cart 10 is offset to the left relative to the docking station 20, the second guide roller 14b moves to the right while rotating along the second fillet 24br of the second guide part 24b, whereby the cart 10 may be gradually aligned with the docking station 20.

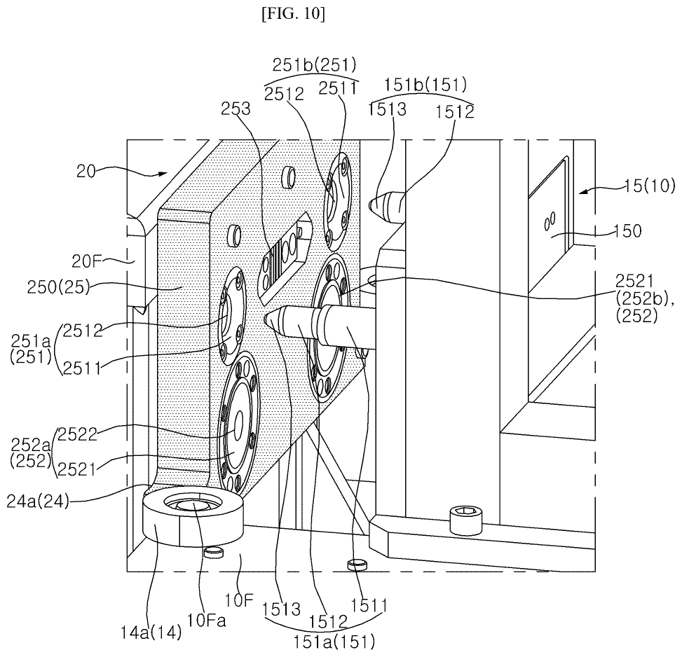

Referring to FIG. 10, as the cart 10 moves forward toward the docking station 20, the guide pin 151 of the connection unit 15 may approach the guide hole 251 of the docking unit 25. The first guide pin 151a may move toward the first guide hole 251a, and the second guide pin 151b may move toward the second guide hole 251b.

The guide pin 151 may include a first part 1511, a second part 1512, and a third part 1513. The first part 1511 may extend forward from the front of the block 150, and may have a cylindrical shape. The second part 1512 may extend forward from a front end of the first part 1511, and may have a cylindrical shape with a smaller diameter than the first part 1511. The third part 1513 may extend from a front end of the second part 1512, and may have a conical shape. The third part 1513 may be referred to as a tip of the guide pin 151.

The guide hole 251 may include a guide surface 2511 and an insertion hole 2512. The diameter of the guide surface 2511 may gradually decrease from the rear to the front. The guide surface 2511 may be referred to as a tapered surface 2511 or a conical surface 2511. The insertion hole 2512 may be formed in the center of the guide surface 2511, and may be a round hole. The insertion hole 2512 may be an internal space of a bushing inserted in the center of the guide surface 2511. The diameter of the insertion hole 2512 may be equal to or greater than the diameter of the first part 1511 of the guide pin 151. The guide hole 251 may be referred to as a countersink hole 251.

As the cart 10 moves forward toward the docking station 20, the guide pin 151 of the connection unit 15 may be inserted into the guide hole 251 of the docking unit 25. At this time, even if the cart 10 is offset to the right relative to the docking station 20, the third parts 1513 of the first and second guide pins 151a and 151b move to the left along the guide surfaces 2511 of the first and second guide holes 251a and 251b, respectively, whereby the cart 10 may be gradually aligned with the docking station 20. Alternatively, even if the cart 10 is offset to the left relative to the docking station 20, the third parts 1513 of the first and second guide pins 151a and 151b move to the right along the guide surfaces 2511 of the first and second guide holes 251a and 251b, respectively, whereby the cart 10 may be gradually aligned with the docking station 20.

The guide operation of the guide roller 14 and the guide part 24 described above with reference to FIGS. 8 and 9 may be referred to as a first guide operation, and the guide operation of the guide pin 151 and the guide hole 251 described above with reference to FIG. 10 may be referred to as a second guide operation. For example, the first guide operation may start before the second guide operation, and the second guide operation may start during the first guide operation and end after the first guide operation. Alternatively, the second guide operation may start before the first guide operation or may start simultaneously with the first guide operation. As a result, the cart 10 may be aligned with the docking station 20. Accordingly, the cart 10 may be guided precisely to the docking station 20.

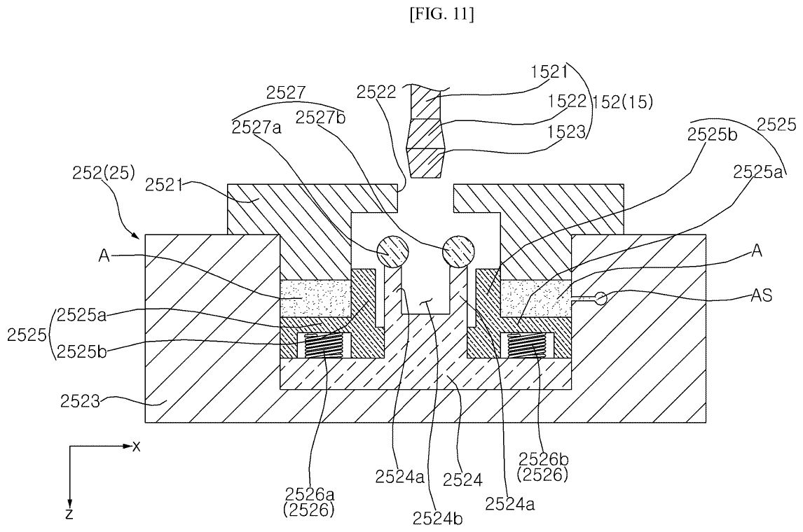

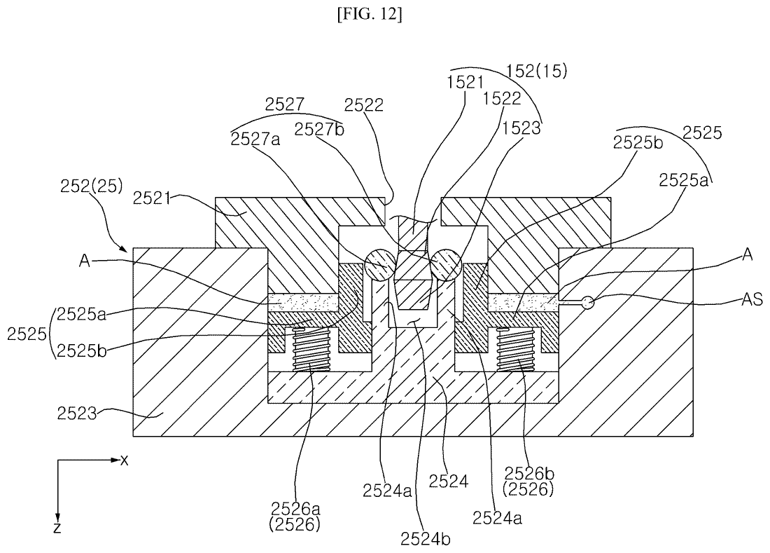

Referring to FIGS. 11 and 12, as the cart 10 moves forward toward the docking station 20, the fixing pin 152 of the connection unit 15 may approach the fixing unit 252 of the docking unit 25. The first fixing pin 152a may move toward the first fixing unit 252a, and the second fixing pin 152b may move toward the second fixing unit 252b (see FIGS. 6 and 10).

The fixing pin 152 may include a body portion 1521, a catching portion 1522, and an insertion portion 1523. The body portion 1521 may extend forward from the front of the block 150 (see FIG. 6), and may have a cylindrical shape. The catching portion 1522 may extend forward from a front end of the body portion 1521, and may have a diameter that gradually increases from the rear to the front. The insertion portion 1523 may extend forward from a front end of the catching portion 1522, and may have a diameter that gradually decreases from the rear to the front. The maximum diameter of the fixing pin 152 may be defined at the boundary between the catching portion 1522 and the insertion portion 1523.

The fixing unit 252 includes a top part 2521, a bottom part 2523, a support part 2524, a moving part 2525, an elastic member 2526, balls 2527, and a fluid A.

The top part 2521 may be located parallel to the front of the base 250 (see FIG. 10), and a fixing hole 2522 may be formed in the center of the top part 2521. The bottom part 2523 may support the top part 2521, and may accommodate the support part 2524, the moving part 2525, the elastic member 2526, the fixing member 2527, and the fluid A.

The support part 2524 may be located between the bottom part 2523 and the top part 2521, and may include pillars 2524a. The moving part 2525 may be located between the support part 2524 and the top part 2521, and may surround side surfaces of the pillars 2524a. The elastic member 2526 may be located between the support part 2524 and a horizontal portion 2525a of the moving part 2525, and may be a spring that provides elastic force to the horizontal portion 2525a. The balls 2527 may be located on the pillars 2524a, and may be adjacent to a vertical portion 2525b of the moving part 2525.

The fluid A may be provided from a source AS, and may be filled between the moving part 2525 and the top part 2521. For example, the fluid A may be air, and the fixing unit 252 may be a pneumatic clamp. Alternatively, the fixing unit 252 may be a hydraulic clamp.

Referring to FIG. 11, the fixing pin 152 may be inserted between the balls 2527 through the fixing hole 2522. At this time, the fluid A may be filled between the moving part 2525 and the top part 2521, whereby the horizontal portion 2525a of the moving part 2525 may move toward the bottom part 2523 to compress the elastic member 2526, and the vertical portion 2525b of the moving part 2525 may be spaced apart from the balls 2527. The insertion portion 1523 of the fixing pin 152 may be inserted into a space 2524b between the pillars 2524a while pushing away the balls 2527.

Referring to FIG. 12, the insertion portion 1523 of the fixing pin 152 of the fixing pin 152 may pass between the balls 2527 and be located in the space 2524b. At this time, a part of the fluid A may return to the source AS from between the moving part 2525 and the top part 2521, whereby the horizontal part 2525a of the moving part 2525 2525a of the moving part 2525 may move toward the top part 2521 due to the elastic force of the elastic member 2526, and the vertical portion 2525b of the moving part 2525 may push the balls 2527 toward the catching portion 1522 of the fixing pin 152.

As a result, the catching portion 1522 of the fixing pin 152 may be caught by the balls 2527, whereby the fixing pin 152 may be fixed to the fixing unit 252. When the fixing pin 152 is fixed to the fixing unit 252, the cart 10 may remain fixed to the docking station 20 and not move even if the robot arm 19 operates or the cart 10 is located on an uneven road. That is, the fixing pins 152 may support the load applied to the cart 10.

Meanwhile, even if the cart 10 is offset to the right relative to the docking station 20, the insertion portions 1523 of the first and second fixing pins 152a and 152b may move to the left along the fixed holes 2522 of the first and second fixing units 252a and 252b, whereby the cart 10 may be gradually aligned with the docking station 20 (see FIGS. 6 and 10). Alternatively, even if the cart 10 is offset to the left relative to the docking station 20, the insertion portions 1523 of the first and second fixing pins 152a and 152b may move to the right along the fixed holes 2522 of the first and second fixing units 252a and 252b, whereby the cart 10 may be gradually aligned with the docking station 20 (see FIGS. 6 and 10). Like this, the fixing pin 152 and the fixing unit 252 not only serve as a structure for fixing the cart 10 to the docking station 20 but also as a structure for aligning the cart 10 with the docking station 20.

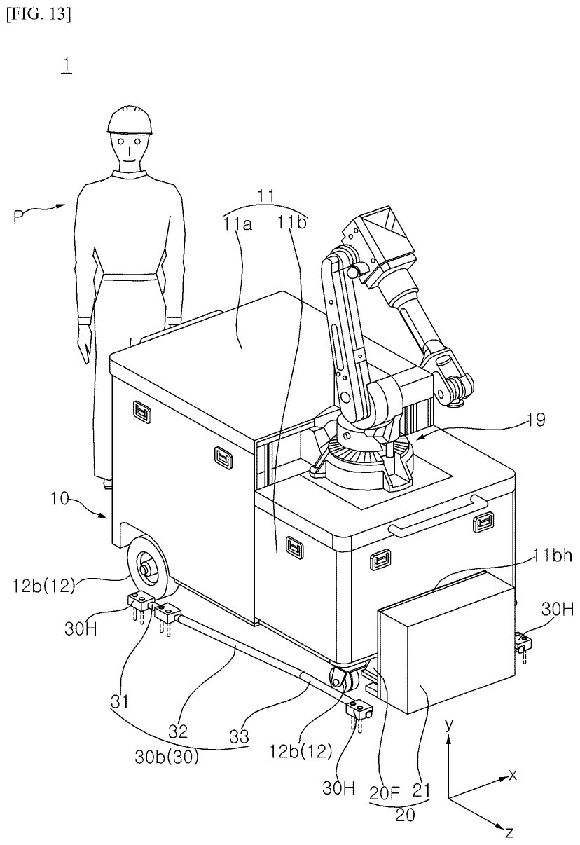

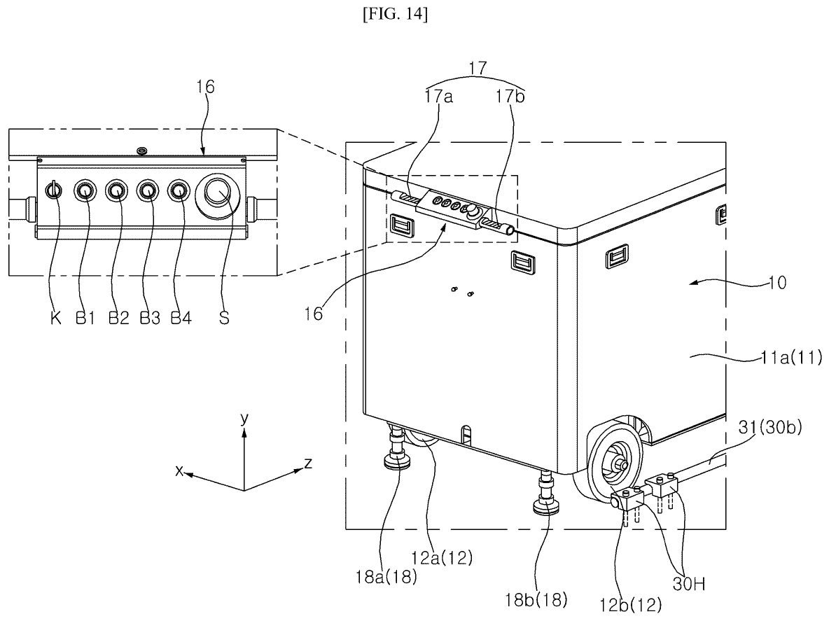

Referring to FIGS. 13 and 14, the cart 10 may dock with the docking station 20.

At this time, the pair of driving wheels 12 may be located between the rear parts 31 of the first and second guide rails 30a and 30b. The distance between the pair of driving wheels 12 may be equal to or less than the distance D1 (see FIG. 2) between the rear parts 31 of the first and second guide rails 30a and 30b.

In addition, the guide pin 151 and the fixing pin 152 of the connection unit 15 may be inserted into the guide hole 251 and the fixing unit 252 of the docking unit 25, respectively, (see FIGS. 6 and 10), and the first connector 153 of the connection unit 15 may be electrically connected to the second connector 253 of the docking unit 25 (see FIGS. 6 and 10). The first and second connectors 153 and 253 may be referred to as multi connectors 153 and 253. The first connector 153 of the connection unit 15 may be referred to as a jack 153, and the second connector 253 of the docking unit 25 may be referred to as a port 253.

A control unit 16 may be mounted on an upper end of the rear of the cart 10. The user may operate the cart 10 by manipulating a plurality of buttons B1, B2, B3, B4, and S of the control unit 16. When the first and second connectors 153 and 253 are (mechanically) connected to each other, light may be emitted from a light source such as a key switch K of the control unit 16 or a light emitting diode (LED) around the key switch K (e.g., LED flashing). Depending on user input, such as turning the key switch K, a part of the fluid A may return to the source AS from between the moving part 2525 and the top part 2521, whereby the fixing pin 152 may be fixed to the fixing unit 252 (see FIG. 12).

Accordingly, the cart 10 may be fixed to the docking station 20 by the user input, and the first and second connectors 153 and 253 may be activated such that the cart 10 and the docking station 20 can be electrically connected to each other. In this case, the cart 10 may be supplied with power from the docking station 20, operate the source AS (see FIGS. 11 and 12) by the docking station 20, or perform communication through the docking station 20. This power supply and communication connection may be used to operate the robot arm 19 mounted on the cart 10.

That is, the user may easily secure the usability of the robot by manipulating the key switch K. In addition, the user may apply power to the robot arm 19 by manipulating the key switch K, whereby work safety may be improved.

Meanwhile, the user may lower a foot 18 from the cart 10 docked with the docking station 20 to the ground. The foot 18 may support the cart 10 on the ground.

Handles 17a and 17b may be provided at both ends of the control unit 16. The user P may move the cart 10 while holding the handles 17a and 17b to dock the cart 10 with the docking station 20 or to separate the cart from the docking station. At this time, the user P may fill the fluid A of the source AS between the moving part 2525 and the top part 2521 by manipulating the key switch K (see FIG. 11), and the cart 10 may be separated from the docking station 20 in the state in which the fixing pin 152 is not constrained by the fixing unit 252.

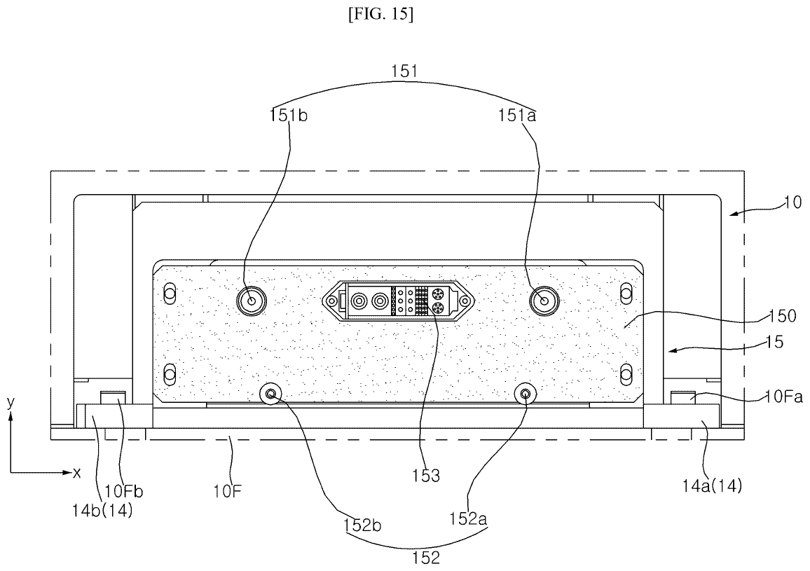

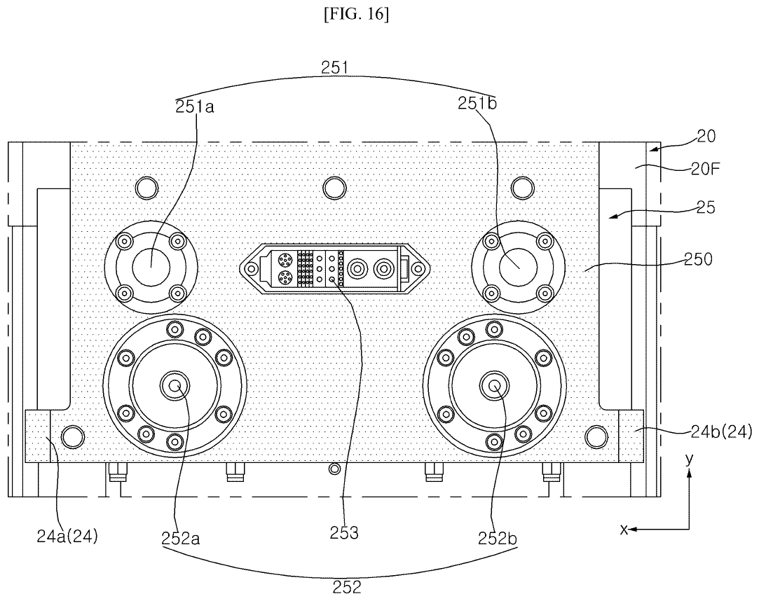

Referring to FIGS. 15 and 16, when the connection unit 15 is docked with the docking unit 25, the front of the block 150 of the connection unit 15 may come into contact with the rear of the base 250 of the docking unit 25. As a result, even if the robot arm 19 moves or the cart 10 is located on an uneven road surface, the cart 10 may remain fixed to the docking station 20 without moving. That is, the front of the block 150 and the rear of the base 250 in contact with each other may support the load applied to the cart 10, and may minimize the cart 10 from twisting or rotating relative to the docking station 20. In addition, the fixing pin 152 may minimize sliding of the front of the block 150 on the rear of the base 250.

Furthermore, a certain distance may be formed between the first connector 153 and the block 150 and between the second connector 253 and the base 250. Accordingly, the load applied to the cart 10 may not be transmitted to the first and second connectors 153 and 253.

Referring to FIGS. 1 to 16, a robot according to an aspect of the present disclosure may include a movable cart including a wheel and a docking station to which the cart is connected or from which the cart is separated.

The robot may further include a robot arm mounted on the cart.

The robot may further include a guide rail aligned with the docking station between the cart and the docking station, wherein the wheel may be movable along the guide rail.

The guide rail may include a pair of guide rails opposite each other with respect to the docking station, and the wheel may include a pair of caster wheels located between the pair of guide rails.

An area between the pair of guide rails may include an entry area located farthest from the docking station, the entry area having a maximum width, a docking area located closest to the docking station, the docking area having a minimum width, and a guide area located between the entry area and the docking area, the guide area having a width gradually decreasing toward the docking area.

The cart may include a frame on which the wheel is mounted, a case configured to cover the frame, the case having a hole formed in one surface of the case facing the docking station, and a pair of guide rollers provided adjacent to the hole, the pair of guide rollers being rotatably coupled to the frame, the pair of guide rollers being spaced apart from each other, the docking station may include a docking unit located in the hole, the docking unit having a pair of guide parts located between the pair of guide rollers, and the guide part may include a round surface facing the guide roller.

A rotation axis of the guide roller may be parallel to a vertical direction, and the pair of guide parts may include a first guide part protruding from a first side surface of the docking unit and a second guide part protruding from a second side surface of the docking unit opposite the first side surface.

The cart may include a frame, a block mounted on the frame, the block facing the docking station, and a guide pin protruding from the block toward the docking station, and the docking station may include a base facing the block and a guide hole formed in the base, the guide hole being configured to allow the guide pin to be inserted thereinto.

The guide pin may include a pair of guide pins spaced apart from each other in a width direction of the block, and the guide hole may include a pair of guide holes into which the pair of guide pins is inserted.

The guide pin may include a tip forming an end of the guide pin, the tip having a conical shape, and the guide hole may be a countersink hole having a guide surface corresponding in shape to the tip.

The cart may further include a first connector mounted on one surface of the block facing the base, and the docking station may further include a second connector mounted on one surface of the base facing the block, the second connector being connected to the first connector.

The cart may further include a fixing pin protruding from the block toward the docking station, and the docking station may further include a fixing unit formed at the base, the fixing unit being configured to allow the fixing pin to be inserted thereinto.

The fixing pin may include a pair of fixing pins spaced apart from each other in the width direction of the block, and the fixing unit may include a pair of fixing units into which the pair of fixing pins is inserted.

The one surface of the block may be in contact with the one surface of the base.

The fixing unit may fix the fixing pin inserted into the fixing unit to the fixing unit based on user input when the first connector is coupled to the second connector.

The first connector may be electrically connected to the second connector when the fixing pin is fixed to the fixing unit.

The fixing unit may be a pneumatic clamp, and the cart may further include a light source configured to indicate coupling between the first connector and the second connector and a switch configured to control the operation of the pneumatic clamp.

Certain embodiments or other embodiments of the invention described above are not mutually exclusive or distinct from each other. Any or all elements of the embodiments of the invention described above may be combined with each other in configuration or function.

For example, a configuration “A” described in one embodiment of the invention and the drawings and a configuration “B” described in another embodiment of the invention and the drawings may be combined with each other. Namely, although the combination between the configurations is not directly described, the combination is possible except for the case where it is described that the combination is impossible.

The above detailed description is to be construed in all aspects as illustrative and not restrictive. The scope of the present disclosure is to be determined by reasonable interpretation of the appended claims, and all changes within the equivalent scope of the present disclosure are included in the scope of the present disclosure.

1. A robot comprising:
a movable cart including a wheel;
a robot arm mounted on the cart;
a docking station to which the cart is connected or from which the cart is separated; and
a guide rail aligned with the docking station between the cart and the docking station,
wherein the wheel is movable along the guide rail.

2. The robot according to claim 1, wherein the guide rail comprises a pair of guide rails opposite each other with respect to the docking station, and
wherein the wheel comprises a pair of caster wheels located between the pair of guide rails.

3. The robot according to claim 2, wherein an area between the pair of guide rails comprises:
an entry area located farthest from the docking station and having a maximum width;
a docking area located closest to the docking station and having a minimum width; and
a guide area located between the entry area and the docking area and having a width gradually decreasing toward the docking area.

4. The robot according to claim 1, wherein the cart comprises:
a frame on which the wheel is mounted;
a case covering the frame, the case having a hole formed in one surface of the case facing the docking station; and
a pair of guide rollers rotatably coupled to the frame adjacent to the hole, and spaced apart from each other,
wherein the docking station comprises a docking unit located in the hole, and
including a pair of guide parts located between the pair of guide rollers, and
wherein the guide part comprises a round surface facing the guide roller.

5. The robot according to claim 4, wherein a rotation axis of the guide roller is parallel to a vertical direction, and
wherein the pair of guide parts comprises:
a first guide part protruding from a first side surface of the docking unit; and
a second guide part protruding from a second side surface of the docking unit opposite the first side surface.

6. The robot according to claim 1, wherein the cart comprises:
a frame;
a block mounted on the frame and facing the docking station; and
a guide pin protruding from the block toward the docking station, and
wherein the docking station comprises:
a base facing the block; and
a guide hole formed in the base and into which the guide pin is insertable.

7. The robot according to claim 6, wherein the guide pin comprises a pair of guide pins spaced apart from each other in a width direction of the block, and
wherein the guide hole comprises a pair of guide holes into which the pair of guide pins is inserted.

8. The robot according to claim 6, wherein the guide pin comprises a tip forming an end of the guide pin and having a conical shape, and
wherein the guide hole is a countersink hole having a guide surface corresponding in shape to the tip.

9. The robot according to claim 6, wherein the cart further comprises a first connector mounted on one surface of the block facing the base, and
wherein the docking station further comprises a second connector mounted on one surface of the base facing the block, and connected to the first connector.

10. The robot according to claim 9, wherein the cart further comprises a fixing pin protruding from the block toward the docking station, and
wherein the docking station further comprises a fixing unit formed at the base, and into which the fixing pin is inserted.

11. The robot according to claim 10, wherein the fixing pin comprises a pair of fixing pins spaced apart from each other in a width direction of the block, and
wherein the fixing unit comprises a pair of fixing units into which the pair of fixing pins is inserted.

12. The robot according to claim 10, wherein the one surface of the block is in contact with the one surface of the base.

13. The robot according to claim 10, wherein the fixing unit fixes the fixing pin inserted into the fixing unit to the fixing unit based on a user input when the first connector is coupled to the second connector.

14. The robot according to claim 13, wherein the first connector is electrically connected to the second connector when the fixing pin is fixed to the fixing unit.

15. The robot according to claim 13, wherein the fixing unit is a pneumatic clamp, and
wherein the cart further comprises:
a light source indicating coupling between the first connector and the second connector; and
a switch controlling an operation of the pneumatic clamp.
